(19) United States
(12) Patent Application Publication
(10) Pub. No.: US 2025/0054122 A1
(43) Pub. Date: Feb. 13, 2025

(54) RISK EVALUATION DEVICE, RISK EVALUATION METHOD, AND RECORDING MEDIUM

(71) Applicant: NEC Corporation, Minato-ku, Tokyo (JP)

(72) Inventors: Chisato SUGAWARA, Tokyo (JP); Toshimichi YOKOTE, Tokyo (JP); Yosuke KIMURA, Tokyo (JP); Yusuke MIZUKOSHI, Tokyo (JP); Takakazu ISHII, Tokyo (JP); Hiromichi HIRATA, Tokyo (JP); Shouhei OHNO, Tokyo (JP); Nana JUMONJI, Tokyo (JP)

(73) Assignee: NEC Corporation, Minato-ku, Tokyo (JP)

(21) Appl. No.: 18/723,491

(22) PCT Filed: Dec. 28, 2021
(86) PCT No.: PCT/JP2021/048772

§ 371 Date: Jun. 24, 2024

(51) Int. Cl. G06T 7/00; G01C 11/04

(52) U.S. Cl. CPC G06T 7/0002; G01C 11/04

(57) ABSTRACT

This risk evaluation method comprises a sensor information acquisition means that acquires sensor information for a structure from a sensor information acquisition device, a stratum information acquisition means that acquires stratum information for the ground under the structure, a risk evaluation means that evaluates risks to the structure on the basis of the sensor information and the stratum information, and an output means that outputs the evaluated risks to the structure.

### TECHNICAL FIELD

The present disclosure relates to a risk evaluation device, a risk evaluation method, and a recording medium.

### BACKGROUND ART

There is a technology of determining the state of a road or a runway using an image acquired by a drive recorder mounted on a vehicle. For example, PTL 1 discloses an in-vehicle device that performs image recognition processing on an image captured by a camera or the like provided in an own vehicle, and detects an abnormal state of a road such as a sagging road or the occurrence of other disasters.

There is also a technology of determining the degree of deterioration in accordance with the type of a surface of a structure. For example, PTL 2 discloses a pavement deterioration determination device that automatically determines a pavement type of a road from a captured road image and capturing position information, and automatically determines the degree of deterioration for each pavement type based on the road image, the capturing position information, and a pavement type determination result.

### CITATION LIST

### Patent Literature

PTL 1: JP 2010-049442 A
PTL 2: JP 2020-147961 A

### SUMMARY OF INVENTION

### Technical Problem

However, in a large structure such as a road, a bridge, or a runway, when the displacement of the ground (a surface stratum) affecting the entire structure occurs, surface deterioration such as cracking occurs. This surface deterioration occurs separately from displacement caused by the deterioration of the structure itself such as the deterioration (individual deterioration) of a surface member. Therefore, the deterioration caused by the displacement of the ground and the individual deterioration require different countermeasures such as repair.

There are various types of grounds, and the progress of the displacement such as ground sinking varies for each type, and thus, the deterioration of the structure on the ground also varies. Therefore, a method of determining the deterioration is different in accordance with the type of ground. The pavement deterioration determination device described in PTL 2 determines the degree of deterioration based on the pavement type of the road such as asphalt or concrete, as the pavement type of the road. However, even in the case of a road provided with the same pavement, the ground structure greatly varies in accordance with a place, and thus, it is difficult to appropriately evaluate the deterioration of the structure.

An object of the present disclosure is to provide a risk evaluation device and the like capable of performing appropriate risk evaluation for a structure.

### Solution to Problem

A risk evaluation device according to one aspect of the present invention includes a sensor information acquisition means for acquiring sensor information of a structure from a sensor information acquisition device, a stratum information acquisition means for acquiring stratum information of ground under the structure, a risk evaluation means for evaluating a risk to the structure based on the sensor information and the stratum information, and an output means for outputting the evaluated risk to the structure.

A risk evaluation method according to one aspect of the present invention acquires sensor information of a structure from a sensor information acquisition device, acquires stratum information of ground under the structure, evaluates a risk to the structure based on the sensor information and the stratum information, and outputs the evaluated risk to the structure.

A recording medium according to one aspect of the present invention records a program for allowing a computer to execute acquiring sensor information of a structure from a sensor information acquisition device, acquiring stratum information of ground under the structure, evaluating a risk to the structure based on the sensor information and the stratum information, and outputting the evaluated risk to the structure.

### Advantageous Effects of Invention

An example of the effect of the present disclosure is to enable appropriate risk evaluation for the structure.

### BRIEF DESCRIPTION OF DRAWINGS

FIG. 1 is a block diagram illustrating an example of a configuration of a risk evaluation device according to a first example embodiment.

FIG. 2 is a conceptual diagram illustrating an example of the risk evaluation device according to the first example embodiment and a peripheral configuration of the risk evaluation device.

FIG. 3 is a flowchart illustrating an example of an operation of the risk evaluation device according to the first example embodiment.

FIG. 4 is a block diagram illustrating an example of a hardware configuration of the risk evaluation device according to the first example embodiment.

FIG. 5 is a block diagram illustrating an example of a configuration of a risk evaluation device according to a second example embodiment.

FIG. 6 is a flowchart illustrating an example of an operation of the risk evaluation device according to the second example embodiment.

### EXAMPLE EMBODIMENT

Next, example embodiments of the present invention will be described with reference to the drawings. Each drawing is for describing the example embodiments of the present invention. However, the example embodiments of the present invention are not limited to the description of each drawing. The same reference numerals will be applied to the same configurations in each drawing, and the repeated description of the same configurations may be omitted. In the drawings used in the following description, the configuration of portions that are not relevant to the solution of the problem of the present invention may be omitted and not illustrated.

### First Example Embodiment

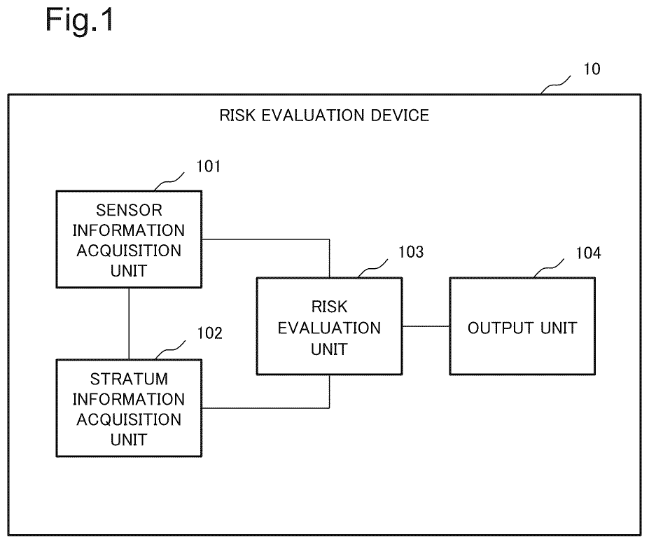

FIG. 1 is a block diagram illustrating an example of the configuration of a risk evaluation device 10 according to a first example embodiment. The risk evaluation device 10 includes a sensor information acquisition unit 101, a stratum information acquisition unit 102, a risk evaluation unit 103, and an output unit 104. Each configuration may store at least a part of the information specified by each configuration, the acquired information, and the determined information in a storage unit (not illustrated). In this case, each configuration may acquire necessary information from the storage unit. The risk evaluation device 10 is a device for evaluating a risk such as the deterioration of a structure based on sensor information acquired from a sensor information acquisition device and stratum information of the ground under the structure. Examples of the structure include a civil structure such as a road, a bridge, a slope frame, a dike, a pier, a revetment, or a runway.

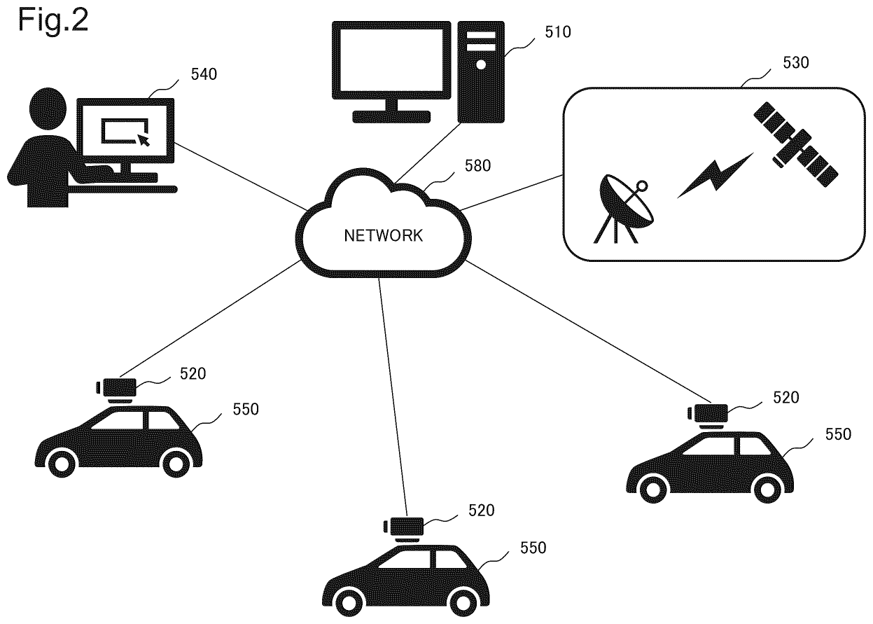

FIG. 2 is a conceptual diagram illustrating an example of the risk evaluation device 10 according to the first example embodiment and the peripheral configuration of the risk evaluation device. As illustrated in FIG. 2, the risk evaluation device 10 is used as a system including a computer 510, a drive recorder 520 as an example of the sensor information acquisition device, a synthetic aperture radar system (hereinafter referred to as SAR) 530, a terminal device 540 as an example of a display device, and a vehicle 550 as an example of a mobile body. However, in the present example embodiment, the SAR 530 is not an essential configuration. A network 580 is a communication path that connects devices and systems to each other. The risk evaluation device 10 (the computer 510) and the drive recorder 520 may be directly connected to each other, or may be connected to each other via a network or the like.

The drive recorder 520 outputs the sensor information to the risk evaluation device 10. The sensor information is information acquired from a sensor in order to determine the situation of the structure and the situation around the structure. Examples of the sensor include a camera, a speedometer, and an accelerometer. The drive recorder 520, for example, is mounted on the mobile body, and acquires the sensor information. Examples of the mobile body include a vehicle and a drone. Instead of the drive recorder 520, the sensor information may be acquired using a fixed camera attached to a mobile body, a camera brought into a mobile body by a person or the like, or a fixed camera installed on a road. Instead of the drive recorder 520, a fixed camera such as a whole-sky camera attached to a mobile body or an in-vehicle camera may be used. The sensor information may be acquired using a camera mounted on a smart phone or a tablet carried brought into a mobile body by a person or the like or a fixed camera installed on a road.

The SAR 530 is a radar system that transmits and receives radio waves while a flying body such as an artificial satellite or an aircraft is moving, and obtains an image equivalent to that in the case of an antenna having a large aperture. The SAR 530 outputs a measurement image (an SAR image) or a ground surface displacement to the risk evaluation device 10.

The terminal device 540 displays risk information for the structure output by the risk evaluation device 10. The terminal device 540 may be any device insofar as the risk information for the structure can be displayed. The terminal device 540 may be, for example, a terminal device of a road manager such as an autonomous body.

The number of configurations included in FIG. 2 is an example. For example, the drive recorder 520 may be singular or plural. Alternatively, at least some of the drive recorders 520 may not be mounted on the vehicle 550. In FIG. 2, the drive recorder 520 is displayed outside the vehicle 550 in order to facilitate understanding. However, the drive recorder 520 may be mounted inside the vehicle 550.

Returning to FIG. 1, the sensor information acquisition unit 101 acquires the sensor information of the structure from the sensor information acquisition device. The sensor information acquisition unit 101 acquires the sensor information at any timing for acquiring the sensor information. In the case of acquiring image data as the sensor information, the sensor information acquisition unit 101 acquires information of a date and time when the image data is acquired and a position where the image data is captured together with the image data. The information of the position includes, for example, position information according to a position on a map, a latitude and a longitude, and a global navigation satellite system (GNSS) or a global positioning system (GPS). The sensor information acquisition unit 101 may acquire information at the time of sensor acquisition such as brightness or darkness, the presence or absence of a shadow, the presence or absence of back light, or ambient weather together with the sensor information.

The stratum information acquisition unit 102 acquires the stratum information of the ground under the structure. The ground is a surface layer portion of the ground surface supporting the foundation of the structure. The stratum information acquisition unit 102 acquires the stratum information of the ground where the structure that is a risk evaluation target exists, for example, from a public database or the like.

The stratum information includes developed land information, a surface stratum, soil information, or topographical information. The developed land information is construction information applied to land in order to convert land other than a residential land to the residential land or the like. The developed land information includes, for example, an embankment such as existing embankment, widening of embankment, a valley filled embankment, a natural ground, and a non-embankment. The surface stratum is a stratum deposited near the ground surface. The surface stratum includes information indicating geological names such as a low-wetland sediment, a natural dike, a sandbar sediment, the Iimuro Formation, the Kakio Formation, the Musashino loam Formation, the Musashino gravel Formation, the Obaradai sand gravel Formation/zengyo gravel Formation, the Shimosueyoshi loam Formation/Shimosueyoshi Formation, the Hayada loam Formation, the Maioka loam Formation, and the Tsurumi Formation/Maioka Formation, or a geological age such as the Middle or Late Pleistocene, the Early Pleistocene, the Holocene, the Late Pleistocene, and the Quaternary. Examples of the soil information include the type of soil such as sand dune regosol, andosol, brown lowland soil, gray lowland soil, lithosol, dark red soil, artificial deformed soil, and artificial deformed area soil, and soil texture such as fine sand, coarse sand, silt, and clay. A stratum or soil which is likely to contain water such as silt or clay is often soft. The topographical information includes a natural topography such as a loam (volcanic ash) plateau, a debris flow depositional area, a hillslope, an old water part, an old river channel, a reduced low-lying land, a river location, a marshy area, a current water part, a sediment terrace, a natural dike, a valley low-lying land, and a colluvial slope/talus slope, or a population geography such as an artificial plain land, a cut land, a reclaimed land, an embankment land, and a gravel pit.

The stratum information may include information relevant to a land and soil other than the stratum. Examples thereof include an (average) inclination angle, the designation of a steep slope, an annual precipitation amount, a rainwater infiltration basin, a difficult drainage lowland, a landslide disaster warning area, a risk of liquefaction, ease of shaking, a landslide disaster warning designation area, a land use type, a category of registered land, and the like. According to such information, the softness of the ground can be grasped. Examples of the land use type include high-rise buildings, low-rise buildings, areas of high low-rise building density, public facilities, factories, exhibition halls, parking lots, parks and green spaces, forests, vacant lands, roads, railways, rivers, lakes and marshes, and coasts. Examples of the category of registered land include a residential land, a wet field, a dry field, a ranch, a wild land, a salt field, an oasis, a pond, a mountain forest, a graveyard, precincts, a canal land, a water supply land, a rough water channel, a reservoir, a bank well, a preservation forest, a public road, a park, a railway land, a school land, and a mixed land. For example, the lowland often seen in the vicinity of the river, the pond, and the like is often soft.

The stratum information acquisition unit 102 may acquire time-series information (stratum history) of the stratum as the stratum information. For example, in the developed land, the state of the soil before and after the development, the change and the movement of the watershed of the river in the past, a development/change schedule of the ground surface, a development plan, an improvement plan, a construction plan such as a plan for construction an underground tunnel or a large building, and the like may be associated with the surrounding construction plan and the like. The ground that was in the watershed of the river in the past is often soft. The risk evaluation unit 103 may use one piece of stratum information or a plurality of pieces of stratum information. The stratum information used in the risk evaluation unit 103 may be fixed, but may be optionally designated by a user.

The risk evaluation unit 103 evaluates a risk to the structure based on the sensor information and the stratum information input from each of the sensor information acquisition unit 101 and the stratum information acquisition unit 102. The risk evaluation unit 103 specifies the location of the deteriorated structure using a learned model. The learning model is a model learned using the sensor information such as an image obtained by imaging the structure and an acceleration as training data, and outputs the presence or absence of the deterioration of the structure to the sensor information. However, a method for specifying the location of the deterioration by the risk evaluation unit 103 is not limited to the above. The risk evaluation unit 103 may specify the location of the deterioration without using the learned model. For example, the risk evaluation unit 103 may specify the location of the deterioration based on the edge or the line of the structure detected by image processing. The risk evaluation unit 103 may convert acceleration data into an international roughness index (IRI) described below by a predetermined method, and specify the location of the deterioration using IRI. IRI is an index in which the road surface and the ride comfort of a driver are associated with each other, and represents the degree of unevenness as a numerical value.

Next, the risk evaluation unit 103 evaluates a risk to the structure based on the stratum information of the ground under the structure of which the deterioration is specified. The risk evaluation is to evaluate the presence or absence of a risk and the degree of risk based on a factor that may cause the deterioration of the structure. For example, a stratum containing soil that is likely to contain water, such as silt or clay, expands (frost-heaves) due to freezing inside the stratum, and cracking may occur on the surface of the structure. Therefore, in a case where the stratum that is likely to contain water is included as the stratum information, the risk evaluation unit 103 evaluates that there is a risk of cracking of the structure due to freezing. On the other hand, a stratum with low moisture content or excellent drainage properties, such as a sand layer, a sand gravel layer, or a bedrock, is hardly affected by the frost heave. In this case, the risk evaluation unit 103 evaluates that a risk of deterioration of the structure due to the frost heave is low. In a case where a stratum that is likely to fluctuate due to heat or a pressure is included, the risk evaluation unit 103 evaluates that expansion and compression inside the stratum may affect the cracking of the structure.

In a case where an embankment is included as the stratum information, the risk evaluation unit 103 evaluates that there is a risk of ground sinking due to the embankment or the soft ground of the embankment. That is, there is a possibility that in the ground subjected to the embankment in the valley or the slope, the ground sinking occurs due to the weight of the soil of the embankment itself. In a case where a construction waste material such as glass is mixed in the soil subjected to the embankment, the ground is weak, and there is a possibility of ground sinking. As described above, the risk evaluation unit 103 evaluates a risk to the structure that may occur in accordance with the stratum information of the ground of the land subjected to the embankment.

In the case of evaluating a risk, the risk evaluation unit 103 may further use information relevant to the environment of the structure acquired from a database. The database is, for example, a database in which weather data and traffic data are stored. The database may be a database independently created by the user, or may be publicly available. The weather data is, for example, precipitation amount information or temperature information disclosed on a website of the Meteorological Office or the like. For example, the risk evaluation unit 103 evaluates that an area having a large precipitation amount or an area with an extremely low temperature has a risk of deterioration due to the precipitation amount or the temperature. For example, the risk evaluation unit 103 evaluates that there is a risk of deterioration due to a traffic volume on a road or a bridge with a large traffic volume.

The output unit 104 outputs the risk to the structure evaluated by the risk evaluation unit 103. For example, when the risk evaluation unit 103 evaluates a risk to the structure, the output unit 104 notifies the terminal device 540 of information indicating the position of the structure and the risk determined by the risk evaluation unit 103. The output unit 104 may select a notification destination. The output unit 105 may output the risk to, for example, the terminal device 540 of the road manager such as an autonomous body. The output unit 104 may display the information indicating the risk to be superimposed on a map such as a road map, a hazard map, or a large-scale embankment developed land map. Such a map may be capable of selectively displaying municipal names, road names, railway names, river names, or the like. The output unit 104 may display the information indicating the risk centered on a specific point (a facility) on the map.

### [Description of Operation]

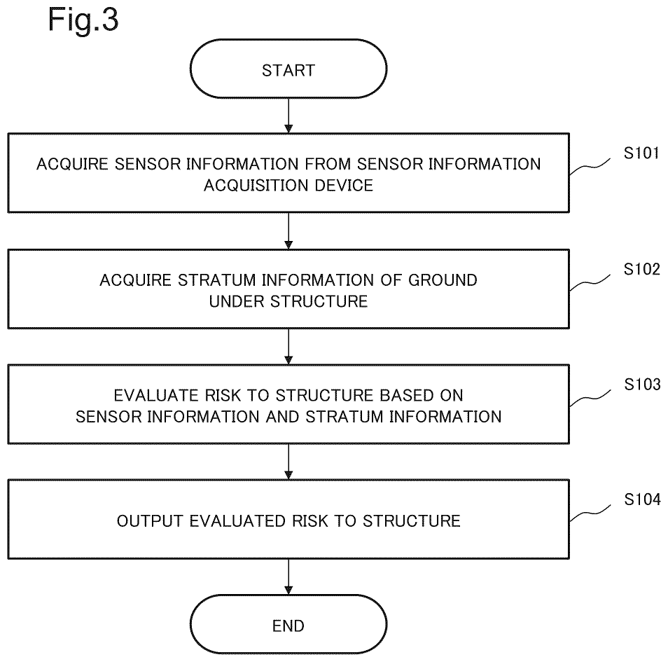

FIG. 3 is a flowchart illustrating an example of the operation of the risk evaluation device 10 according to the first example embodiment. The sensor information acquisition unit 101 acquires the sensor information of the structure from the sensor information acquisition device (step S101). The stratum information acquisition unit 102 acquires the stratum information of the ground under the structure (step S102). The risk evaluation unit 103 evaluates a risk to the structure based on the sensor information and the stratum information (step S103). Next, the output unit 104 outputs the risk to the structure evaluated by the risk evaluation unit 103 (step S104).

In the risk evaluation device 10, the risk evaluation unit 103 evaluates a risk to the structure based on the sensor information and the stratum information. As a result, it is possible to evaluate a risk to the structure in consideration of not only deterioration information of the surface of the structure by the sensor information but also the stratum information of the ground. Therefore, according to the risk evaluation device 10, it is possible to appropriately evaluate a risk to the structure.

### [Hardware Configuration]

Next, a hardware configuration of the risk evaluation device 10 will be described. Each constituent of the risk evaluation device 10 may be configured by a hardware circuit. Alternatively, in the risk evaluation device 10, each constituent may be configured using a plurality of devices connected via a network. For example, the risk evaluation device 10 may be configured using cloud computing. Alternatively, in the risk evaluation device 10, a plurality of constituents may be configured by one piece of hardware. Alternatively, the risk evaluation device 10 may be enabled as a computer device including a central processing unit (CPU), a read only memory (ROM), and a random access memory (RAM). In addition to the above configuration, the risk evaluation device 10 may be enabled as a computer device including a network interface circuit (NIC).

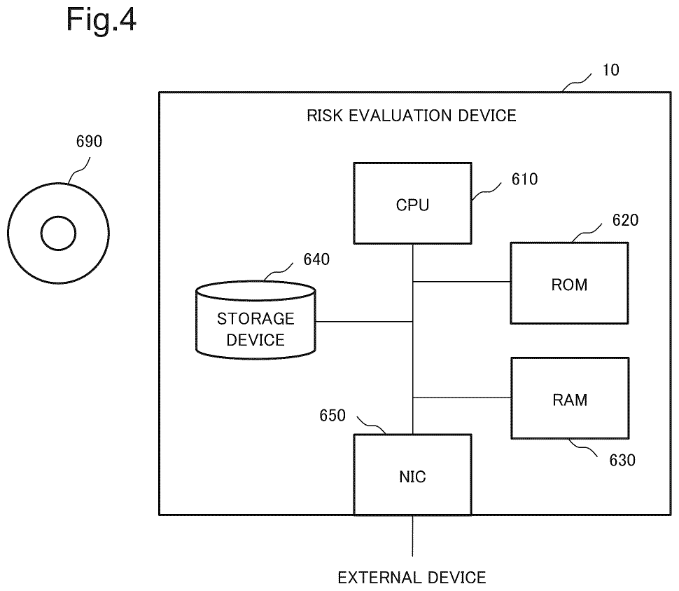

FIG. 4 is a block diagram illustrating an example of a hardware configuration of the risk evaluation device 10. The risk evaluation device 10 includes a CPU 610, a ROM 620, a RAM 630, a storage device 640, and an NIC 650, and configures the computer device. The CPU 610 reads a program from the ROM 620 and/or the storage device 640. The CPU 610 controls the RAM 630, the storage device 640, and the NIC 650 based on the read program. A computer including the CPU 610 controls such a configuration to enable each function as the sensor information acquisition unit 101, the stratum information acquisition unit 102, the risk evaluation unit 103, and the output unit 104 illustrated in FIG. 1.

When enabling each function, the CPU 610 may use the RAM 630 or the storage device 640 as a temporary storage medium of a program and data. Alternatively, the CPU 610 may read a program included in a recording medium 690 storing the program in a computer readable manner using a recording medium reading device (not illustrated). Alternatively, the CPU 610 may receive a program from an external device (not illustrated) via the NIC 650, may store the program in the RAM 630 or the storage device 640, and may be operated based on the stored program.

The ROM 620 stores programs executed by the CPU 610 and fixed data. The ROM 620 is, for example, a programmable-ROM (P-ROM) or a flash ROM. The RAM 630 temporarily stores programs executed by the CPU 610 and data. The RAM 630 is, for example, a dynamic-RAM (D-RAM). The storage device 640 stores data and programs to be stored for a long term by the risk evaluation device 10. The storage device 640 may be operated as a temporary storage device of the CPU 610. The storage device 640 is, for example, a hard disk device, a magneto-optical disk device, a solid state drive (SSD), or a disk array device. The ROM 620 and the storage device 640 are a non-volatile (non-transitory) recording medium. On the other hand, the RAM 630 is a volatile (transitory) recording medium. The CPU 610 can be operated based on the programs stored in the ROM 620, the storage device 640, or the RAM 630. That is, the CPU 610 can be operated using a non-volatile recording medium or a volatile recording medium.

The NIC 650 relays the exchange of data with an external device (the drive recorder 520, the SAR 530, the terminal device 540, the vehicle 550, and the like) via a network. The NIC 650 is, for example, a local area network (LAN) card. The NIC 650 is not limited to wired communication, and may be wireless communication.

### Modification Example of First Example Embodiment

In a modification example of the first example embodiment, a case where a road is mainly used as the structure will be assumed. In the first example embodiment, the risk evaluation unit 103 specifies the location of the deterioration of the structure using the learned model, the image processing, IRI, or the like. However, the risk evaluation unit 103 may specify the location of the deterioration and the progress of the deterioration of the road based on an index indicating the degree of road deterioration. In this case, the risk evaluation unit 103 evaluates a risk to the structure in consideration of information of the progress of the deterioration of the structure.

Here, an index representing the degree of deterioration of each road will be described. There are a plurality of types of road deterioration. The road deterioration is classified into a plurality of types including, for example, cracking, a pothole, rutting, and the abnormal flatness of the road. The cracking may be classified into different types of linear cracks and testudinal cracks depending on the shape. The linear crack is a single linear crack. The testudinal crack is, for example, a tortoise-shell-shaped crack generated in a case where vertical and horizontal linear cracks are connected. The cracking of the road generally tends to progress in the order of the linear crack, the testudinal crack, and the pothole.

The degree of cracking is represented by any one of the shape, the length, the area, and the number of crack or a combination thereof. A cracking rate is an example of the degree of cracking. The cracking rate is represented by, for example, 100×(Area of Cracking/Area of Road Section). In this case, the value of the degree of deterioration is in a range of 0% to 100%. The area of the cracking is calculated by any method. A method for calculating the cracking rate is not particularly limited, and a known calculation method can be applied in addition to the above.

The size of the pothole is represented by, for example, any one of the area, the width, the length, and the depth of the pothole, or a combination thereof. A rutting amount is the depth of a recess continuous in a road extension direction generated at a wheel passage position (a rutting portion) of a vehicle due to a traffic load.

The degree of cracking, the number and size of potholes, and the rutting amount may be calculated based on measurement data obtained by measuring the surface of the road with a sensor. Alternatively, such an index may be calculated based on a recognition result of recognizing the road deterioration from an image obtained by imaging the road.

Flatness may be represented by IRI. IRI may be calculated based on the measurement data obtained by measuring the surface of the road with the sensor. Alternatively, IRI may be calculated based on the value of an acceleration sensor that is traveling by being attached to the vehicle. Specifically, for example, IRI is calculated based on the value of the acceleration in a vertical direction included in the acceleration acquired at a detection position. A method for calculating IRI is not limited to the above, and a known calculation method can be adopted.

The degree of deterioration is not limited to the above-described index, and for example, any index representing the road degradation including maintenance control index (MCI) may be used. The value of MCI is the minimum value of a result of calculating four definition equations using the cracking rate, the rutting amount, and the flatness. MCI decreases as the road deteriorates. In a case where the structure is a runway, a boeing bump index (BBI), which is an index indicating the flatness, can be used.

In the modification example of the first example embodiment described above, the risk evaluation unit 103 evaluates a risk to the structure in consideration of the information of the progress of the deterioration of the structure. As a result, the magnitude of the risk to the structure can be evaluated.

### Second Example Embodiment

Next, a second example embodiment of the present disclosure will be described in detail with reference to the drawings. Hereinafter, the description of the contents overlapping with the above description will be omitted to the extent that the description of the present example embodiment is not unclear.

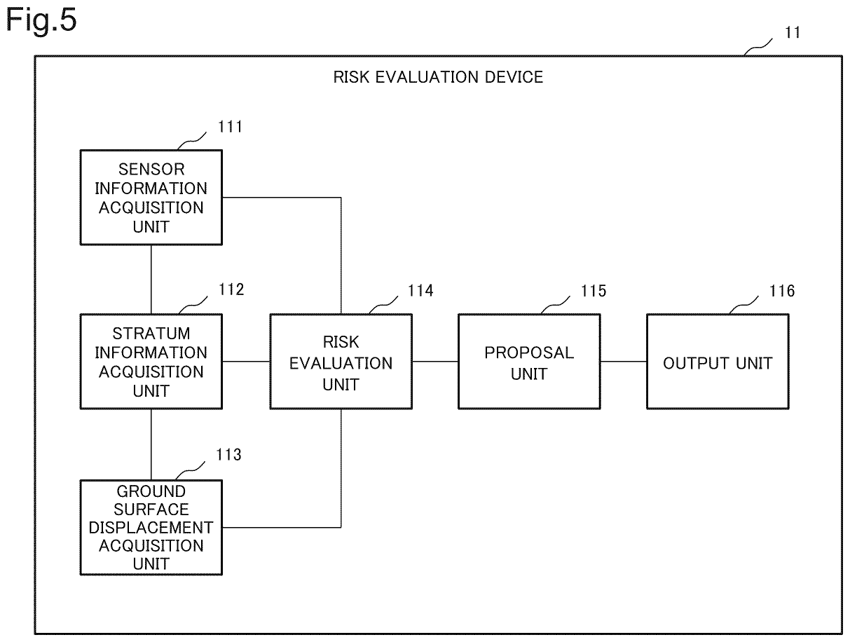

FIG. 5 is a block diagram illustrating an example of the configuration of a risk evaluation device 11 according to the second example embodiment. The risk evaluation device 11 includes a sensor information acquisition unit 111, a stratum information acquisition unit 112, a ground surface displacement acquisition unit 113, a risk evaluation unit 114, a proposal unit 115, and an output unit 116. The second example embodiment is different from the first example embodiment in that the ground surface displacement acquisition unit 113 and the proposal unit 115 are included. Since the configurations of the sensor information acquisition unit 111 and the stratum information acquisition unit 112 are the same as the associated configurations of the first example embodiment, respectively, the description thereof will be omitted.

The ground surface displacement acquisition unit 113 acquires ground surface displacement using a measurement image acquired from a ground surface measurement device. Specifically, the ground surface displacement acquisition unit 113 acquires an SAR image captured by the SAR 530, and acquires the ground surface displacement by analyzing the acquired SAR image. Alternatively, the ground surface displacement acquisition unit 113 may directly acquire the ground surface displacement obtained by analyzing the SAR image captured by the SAR 530. The ground surface displacement may also include information on a ground condition such as ground sinking/uplifting, and building construction and removal. The ground surface displacement acquisition unit 113 may acquire an observation result using multispectral from the SAR 530. In this case, the ground surface displacement acquisition unit 113 may analyze the type of ground surface in addition to the ground surface displacement using the acquired measurement image. The type of ground surface includes at least one of a water surface, mud, waste, dry soil, grassland, forest, farmland, and snow accumulation. The ground surface displacement acquisition unit 113 may use the displacement of an architecture such as a building. The ground surface displacement acquisition unit 113 may acquire the ground surface displacement using an SAR image stored in a cloud system configured using cloud computing to which the drive recorder 520 is connected. The ground surface displacement acquisition unit 113 outputs the acquired ground surface displacement to the risk evaluation unit 114.

The risk evaluation unit 114 evaluates a risk to the structure based on the sensor information, the stratum information, and the ground surface displacement. The risk evaluation unit 114 evaluates a risk to the structure in consideration of the ground surface displacement in addition to the risk evaluation function of the risk evaluation unit 103. For example, the risk evaluation unit 114 evaluates that the risk to the structure increases as the ground surface displacement is larger than a predicted value. Even in a case where the ground surface displacement is not larger than the predicted value, the risk evaluation unit 114 may evaluate that the risk is high for the ground surface that is rapidly displaced and has non-linear ground surface displacement. Here, the predicted value is, for example, ground surface displacement predicted based on the structure or the stratum information. The risk evaluation unit 114 may evaluate a risk to the structure in consideration of the possibility of occurrence of a disaster near the structure based on the ground surface displacement. The risk evaluation unit 114 outputs the acquired evaluated risk to the proposal unit 115.

The proposal unit 115 proposes a countermeasure for the risk to the structure. The proposal unit 115 proposes a countermeasure for repairing or mending the deterioration of the structure based on the risk. The proposal unit 115 refers to a case of a countermeasure accumulated in advance in a database or the like, and outputs a case with similar risk, stratum information or ground surface displacement of the location, or the like. For example, in a case where the ground is weak, and only the surface of the structure is mended without any effective countermeasure, there is a risk that ground sinking occurs and the structure deteriorates again. Therefore, in this case, the proposal unit 115 proposes construction to reinforce the soft ground under the structure. In a case where the ground may be liquefied, the proposal unit 115 proposes a liquefaction countermeasure method such as compacting the ground. There is a possibility that in the ground subjected to the embankment in the valley or the slope, the ground sinking occurs due to the weight of embankment. In this case, the proposal unit 115 proposes construction for providing a retaining wall or the like. In a case where the construction waste material such as glass is mixed in the soil subjected to the embankment, the ground is soft. Therefore, the proposal unit 115 proposes construction for reinforcing the ground. As another example, in a case where the ground under the structure contains soil that is likely to contain moisture, the proposal unit 115 proposes a countermeasure of replacing the ground with soil having excellent drainage properties. However, the example of the countermeasure by the proposal unit 115 is not limited to such examples.

The output unit 116 outputs the countermeasure in addition to the risk to the structure to a predetermined notification destination. For example, in a case where the proposal unit 115 proposes the countermeasure for the risk, the output unit 116 notifies the predetermined notification destination of the information indicating the risk to the structure determined by the risk evaluation unit 114 and the countermeasure. The output unit 116 may select the notification destination. The output unit 116 may output the information and the countermeasure to, for example, the terminal device 540 of the road manager such as an autonomous body.

### [Description of Operation]

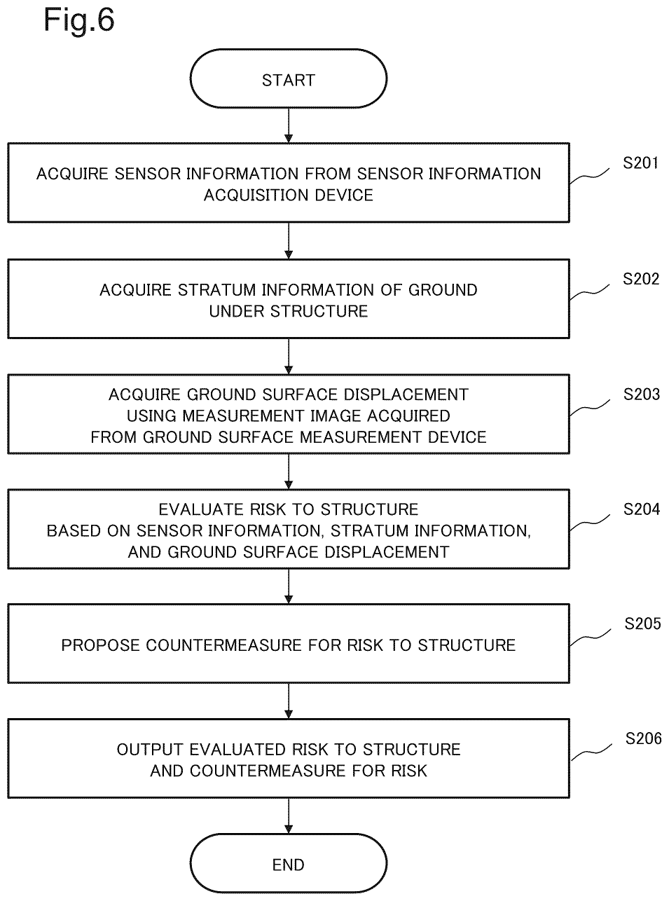

FIG. 6 is a flowchart illustrating an example of the operation of the risk evaluation device 11 according to the second example embodiment. Since steps S201 to S202 in the present example embodiment are the same as steps S101 to S102 in the first example embodiment, the description of the steps will be omitted. The ground surface displacement acquisition unit 113 acquires the ground surface displacement using the measurement image acquired from the ground surface measurement device (step S203). Next, the risk evaluation unit 114 evaluates a risk to the structure based on the sensor information, the stratum information, and the ground surface displacement (step S204). Next, the proposal unit 115 proposes a countermeasure for the risk evaluated by the risk evaluation unit 114 (step S205). Finally, the output unit 116 outputs the countermeasure proposed by the proposal unit 115 in addition to the risk to the structure evaluated by the risk evaluation unit 114 (step S206).

In the risk evaluation device 11 according to the second example embodiment, the risk evaluation unit 114 evaluates a risk to the structure based on the ground surface displacement in addition to the sensor information and the stratum information. As a result, the magnitude of the risk can be evaluated by using information including the magnitude of the ground surface displacement for the risk evaluation. Therefore, a risk to the structure can be more accurately evaluated. In the risk evaluation device 11, the proposal unit 115 proposes the countermeasure for the risk. As a result, a person in charge or the like who manages the structure can immediately respond to the risk with reference to the countermeasure.

Although the present invention has been described above with reference to the example embodiments, the present invention is not limited to the above example embodiments. Various modifications that can be understood by a person skilled in the art can be made to the configuration and the details of the present invention within the scope of the present invention. For example, the proposal unit 115 proposes the countermeasure for the risk to the structure evaluated based on the sensor information, the stratum information, and the ground surface displacement. However, the proposal unit 115 may propose the countermeasure for the risk to the structure evaluated only based on the sensor information and the stratum information. That is, the risk evaluation device 10 according to the first example embodiment may have a configuration corresponding to the proposal unit 115.

Some or all of the above example embodiments may be described as in Supplementary Notes described below, but are not limited to the followings.

### (Supplementary Note 1)

A risk evaluation device, including:
a sensor information acquisition means for acquiring sensor information of a structure from a sensor information acquisition device;
a stratum information acquisition means for acquiring stratum information of ground under the structure;
a risk evaluation means for evaluating a risk to the structure based on the sensor information and the stratum information; and
an output means for outputting the evaluated risk to the structure.

### (Supplementary Note 2)

The risk evaluation device according to supplementary note 1, further including
a ground surface displacement acquisition means for acquiring ground surface displacement using a measurement image acquired from a ground surface measurement device,
in which the risk evaluation means evaluates a risk to the structure based on the sensor information, the stratum information, and the ground surface displacement.

### (Supplementary Note 3)

The risk evaluation device according to supplementary note 1 or 2, in which
the risk evaluation means evaluates a risk to the structure by further using information relevant to an environment of the structure acquired from a database.

### (Supplementary Note 4)

The risk evaluation device according to supplementary note 3, in which
the risk evaluation means evaluates a risk to the structure by acquiring weather information from the database.

### (Supplementary Note 5)

The risk evaluation device according to any one of supplementary notes 1 to 4, in which
when a stratum that is likely to contain water is included as the stratum information,
the risk evaluation means evaluates that there is a risk of cracking due to frost heave.

### (Supplementary Note 6)

The risk evaluation device according to any one of supplementary notes 1 to 4, in which
when an embankment is included as the stratum information,
the risk evaluation means evaluates that there is a risk of ground sinking due to the embankment or soft ground of the embankment.

### (Supplementary Note 7)

The risk evaluation device according to any one of supplementary notes 1 to 6, further including
a proposal means for proposing a countermeasure for the evaluated risk to the structure,
in which the output means outputs the risk to the structure and the countermeasure.

### (Supplementary Note 8)

The risk evaluation device according to any one of supplementary notes 1 to 7, in which
the sensor information is image data obtained by capturing a structure on which a mobile body travels.

### (Supplementary Note 9)

The risk evaluation device according to supplementary note 8, in which
the structure is a road.

### (Supplementary Note 10)

A situation determination method, including:
acquiring sensor information from a sensor information acquisition device;
acquiring stratum information of ground under a structure;
evaluating a risk to the structure based on the sensor information and the stratum information; and
outputting the evaluated risk to the structure.

### (Supplementary Note 11)

A recording medium recording a program for allowing a computer to execute:
acquiring sensor information from a sensor information acquisition device;
acquiring stratum information of ground under a structure;
evaluating a risk to the structure based on the sensor information and the stratum information; and
outputting the evaluated risk to the structure.

### REFERENCE SIGNS LIST

10, 11 risk evaluation device
101, 111 sensor information acquisition unit
102, 112 stratum information acquisition unit
103, 114 risk evaluation unit
104, 116 output unit
113 ground surface displacement acquisition unit
115 proposal unit
510 computer
520 drive recorder
530 SAR
540 terminal device
550 vehicle
580 network
610 CPU
620 ROM
630 RAM
640 storage device
650 NIC

What is claimed is:

1. A risk evaluation device comprising:
a memory storing instructions; and
at least one processor configured to execute the instructions to:
acquire sensor information of a structure from a sensor information acquisition device;
acquire stratum information of ground under the structure;
evaluate a risk to the structure based on the sensor information and the stratum information; and
output the evaluated risk to the structure.

2. The risk evaluation device according to claim 1, wherein the at least one processor is further configured to execute the instructions to:
acquire ground surface displacement using a measurement image acquired from a ground surface measurement device; and
evaluate a risk to the structure based on the sensor information, the stratum information, and the ground surface displacement.

3. The risk evaluation device according to claim 1, wherein the at least one processor is further configured to execute the instructions to:
evaluate a risk to the structure by further using information relevant to an environment of the structure acquired from a database.

4. The risk evaluation device according to claim 3, wherein the at least one processor is further configured to execute the instructions to:
evaluate a risk to the structure by acquiring weather information from the database.

5. The risk evaluation device according to claim 1, wherein the at least one processor is further configured to execute the instructions to:
when a stratum that is likely to contain water is included as the stratum information, evaluate that there is a risk of cracking due to frost heave.

6. The risk evaluation device according to claim 1, wherein the at least one processor is further configured to execute the instructions to:
when an embankment is included as the stratum information, evaluate that there is a risk of ground sinking due to the embankment or soft ground of the embankment.

7. The risk evaluation device according to claim 1, wherein the at least one processor is further configured to execute the instructions to:
propose a countermeasure for the evaluated risk to the structure; and
output the risk to the structure and the countermeasure.

8. The risk evaluation device according to claim 1, wherein
the sensor information is image data obtained by capturing a structure on which a mobile body travels.

9. The risk evaluation device according to claim 8, wherein
the structure is a road.

10. A situation determination method, comprising:
acquiring sensor information of a structure from a sensor information acquisition device;
acquiring stratum information of ground under the structure;
evaluating a risk to the structure based on the sensor information and the stratum information; and
outputting the evaluated risk to the structure.

11. A non-transitory computer recording medium recording a program for allowing a computer to execute:
acquiring sensor information of a structure from a sensor information acquisition device;
acquiring stratum information of ground under the structure;
evaluating a risk to the structure based on the sensor information and the stratum information; and
outputting the evaluated risk to the structure.
